(19) United States
(12) Patent Application Publication
(10) Pub. No.: US 2015/0060105 A1
(43) Pub. Date: Mar. 5, 2015

(54) CABLE ASSEMBLY

(71) Applicant: HON HAI PRECISION INDUSTRY CO., LTD., New Taipe (TW)

(72) Inventors: YI-FANG WU, New Taipei (TW); FOO SEE WOEI, Shenzhen (CN)

(21) Appl. No.: 14/471,275

(22) Filed: Aug. 28, 2014

(30) Foreign Application Priority Data
Aug. 29, 2013 (CN) 2013103840020

(51) Int. Cl. H01B 7/40

(52) U.S. Cl. CPC H01B 7/40
USPC 174/106 R

(57) ABSTRACT

A cable assembly includes a cable and a conduction sleeve. The cable includes a core. The conductive sleeve includes a wrapping piece. The wrapping piece includes a first conduction piece and a second conduction piece. The first conduction piece and the second conduction piece are secured together. The core is firmly received between and electrically coupled to the first conduction piece and the second conduction piece.

### CROSS-REFERENCE TO RELTATED APPLICATIONS

This application claims priority to Chinese Patent Application No. 201310384002.0, filed on Aug. 29, 2013 in the China Intellectual Property Office, the contents of which are incorporated by reference herein.

### FIELD

The subject matter herein generally relates to cable assemblies, and more particularly to a cable assembly with connectors.

### BACKGROUND

In a conventional cable assembly, a connector is mounted on a cable for connecting with another element. When the cable assembly is used for a long time, the connector may become easily disconnected from the cable, which causes the cable assembly to be disabled.

### BRIEF DESCRIPTION OF THE DRAWINGS

Implementations of the present technology will now be described, by way of example only, with reference to the attached figures, wherein:

FIG. 1 is an isometric, exploded view of an embodiment of a cable assembly.

FIG. 2 is similar to FIG. 1, but viewed from another angle.

FIG. 3 is an isometric view of a conductive sleeve of the cable assembly of FIG. 1.

FIG. 4 is similar to FIG. 3, but viewed from another angle.

FIG. 5 is an enlarged view of a circle portion V of FIG. 2.

FIG. 6 is a partially assembled view of the cable assembly of FIG. 1.

FIG. 7 is another partially assembled view of the cable assembly of FIG. 1.

FIG. 8 is similar to FIG. 7, but part of the conductive sleeve is cut off

FIG. 9 is another partially assembled view of the cable assembly of FIG. 1.

FIG. 10 is a fully assembled view of the cable assembly of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

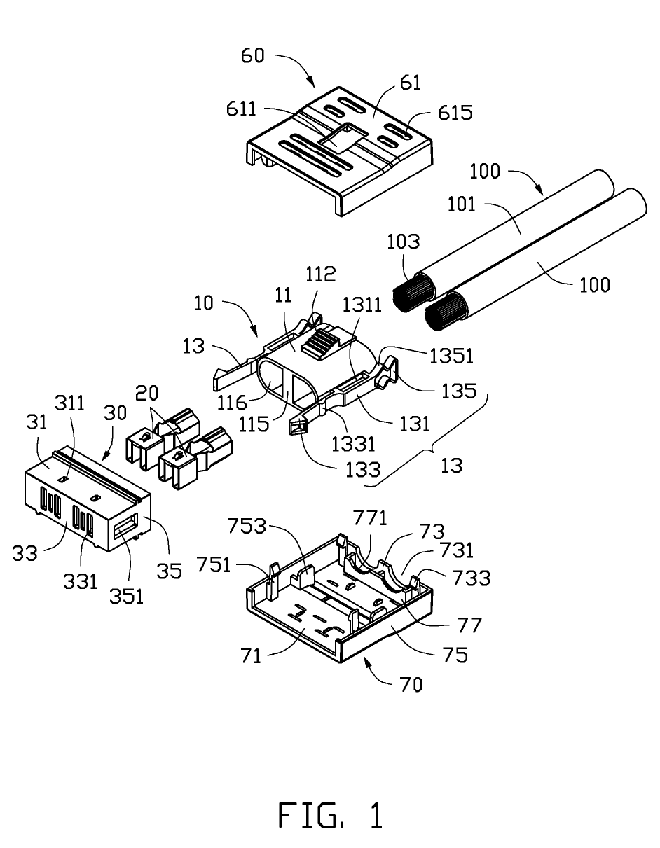

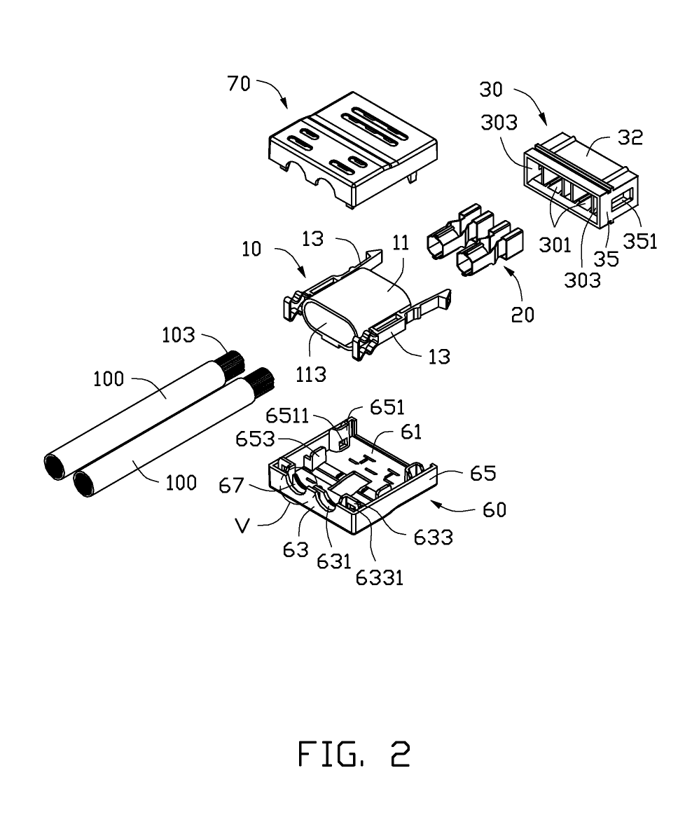

FIGS. 1 and 2 illustrate one embodiment of a cable assembly. The cable assembly includes two cables 100, an accommodating case 10, two conductive sleeves 20, a shell 30, a first case 60, and a second case 70. Each cable 100 includes a core 103 and an insulation tube 101. The insulation tube 101 is wrapped around the core 103.

The accommodating case 10 includes a housing 11, and a pair of engaging arms 13 connected to the housing 11. The housing 11 forms a protrusion 112 thereon. The housing 11 defines a through hole 113. A separating piece 115 divides one end of the through hole 113 into two receiving holes 116. Each receiving hole 116 corresponds to one cable 100. Each engaging arm 13 includes a positioning portion 131, a clasp 133, and an elastic portion 135. The clasp 133 and the elastic portion 135 extend from two respective opposite ends of the positioning portion 131. The positioning portion 131 defines a positioning hole 1311. The clasp 133 includes a rib 1331. The elastic portion 135 includes two elastic pieces 1351 connected to each other.

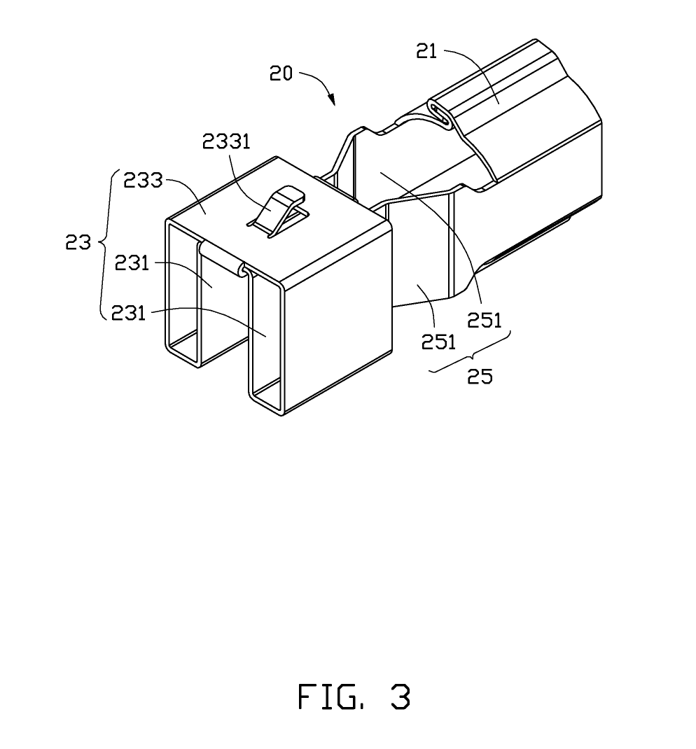

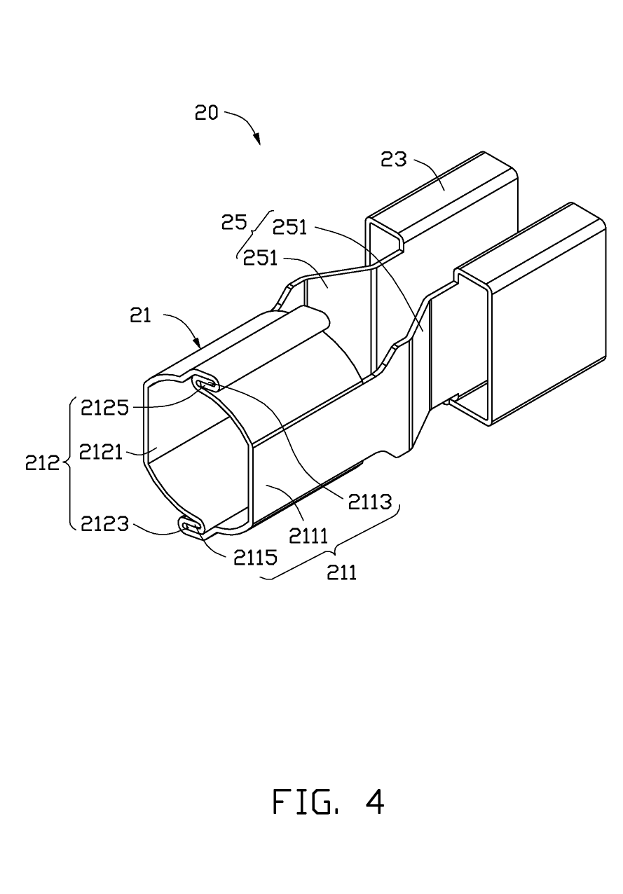

Referring to FIGS. 3 and 4, each conductive sleeve 20 includes a wrapping piece 21, an extending piece 23, and a connecting piece 25. The connecting piece 25 is connected between the wrapping piece 21 and the extending piece 23. The wrapping piece 21 includes a first conduction piece 211 and a second conduction piece 212. The first conduction piece 211 includes a first wrapping portion 2111, a first connection portion 2113, and a second connection portion 2115. The first connection portion 2113 and the second connection portion 2115 extend from respective opposite ends of the first wrapping portion 2111. The second conduction piece 212 includes a second wrapping portion 2121, a third connection portion 2123, and a fourth connection portion 2125. The third connection portion 2123 and the fourth connection portion 2125 extend from respective opposite ends of the second wrapping portion 2121. The first conduction piece 211 and the second conduction piece 212 are connected to each other by the first connection portion 2113 connecting to the fourth connection portion 2125, and the second connection portion 2115 connecting to the third connection portion 2123. The connecting piece 25 includes two bent pieces 251. The extending piece 23 includes two terminals 231 and a top plate 233. The top plate 233 includes an elastic piece 2331. The conductive sleeve 20 is made of conductive material, such as copper, aluminum, and the like.

Referring again to FIGS. 1 and 2, the shell 30 includes a top wall 31, a bottom wall 32, a front wall 33, and two sidewalls 35. The top wall 31 is substantially parallel to the bottom wall 32. The top wall 31 defines two restricting holes 311. The front wall 33 defines two openings 331. Each sidewall 35 defines a clasping hole 351. The shell 30 defines two receiving spaces 301 and two engaging spaces 303 in a back wall (not labeled) thereof.

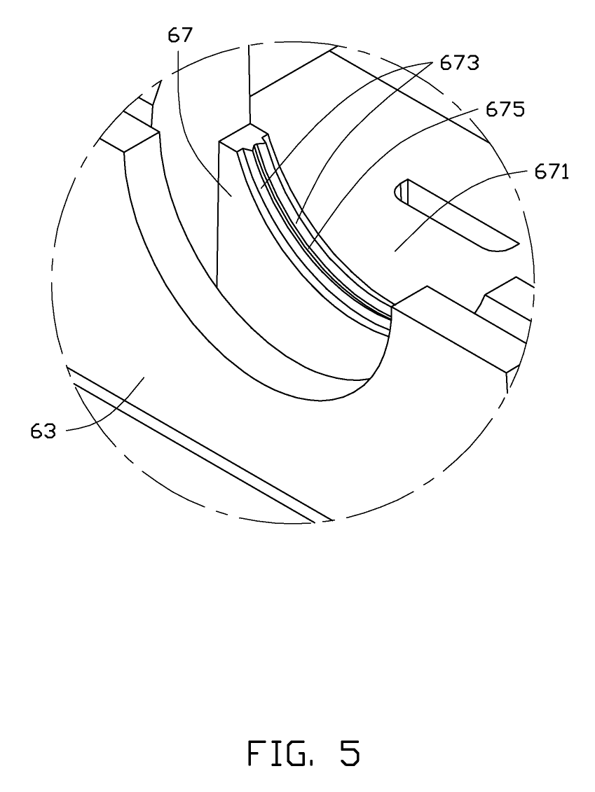

Referring to FIGS. 1, 2, and 5, the first case 60 includes a top piece 61, a first front piece 63, and two first side pieces 65. The top piece 61 defines an opening 611 and a plurality of vent holes 615. A first restricting piece 67 protrudes from a bottom surface of the top piece 61. The first restricting piece 67 is substantially parallel to the first front piece 63. The first front piece 63 defines two first cutouts 631. The first restricting piece 67 defines two first indentations 671 aligned to the two first cutouts 631 one-to-one. Two first elongated ribs 673 protrude from a bounding edge of each first indentation 671. A first restricting groove 675 is defined between the two first elongated ribs 673. Two first restricting portions 633 are located adjacent to two respective front corners of the first case 60. A first restricting hole 6331 is defined in each first restricting portion 633. Two second restricting portions 651 and two first clipping pieces 653 are located adjacent to the two respective first side pieces 65. Each second restricting portion 651 defines a second restricting hole 6511.

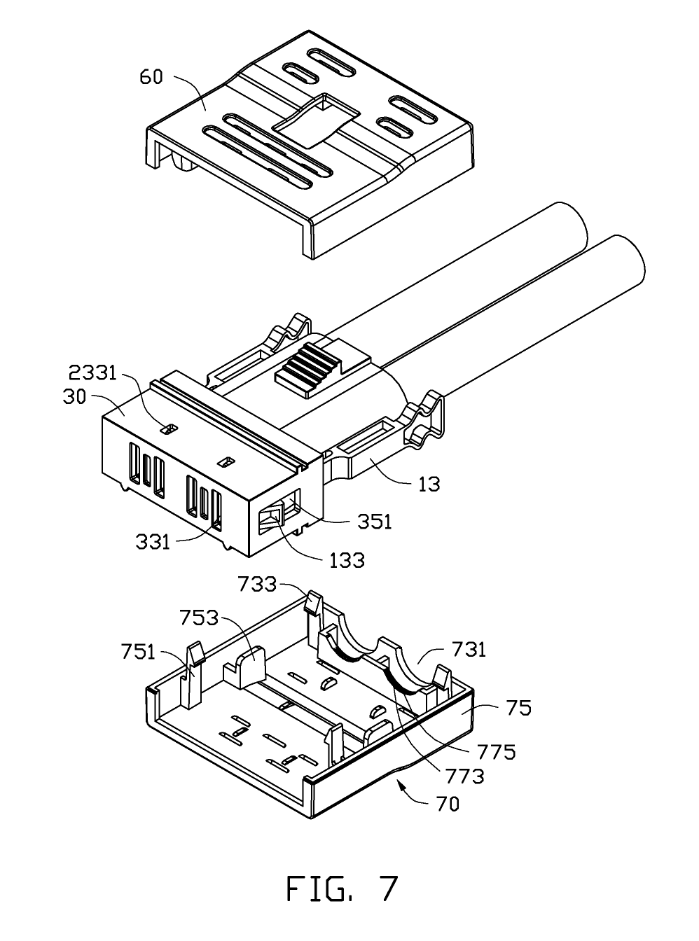

Referring to FIGS. 1, 2, 6, and 7, the second case 70 includes a bottom piece 71, a second front piece 73, and two second side pieces 75. A second restricting piece 77 protrudes from a top surface of the bottom piece 71. The second restricting piece 77 is substantially parallel to the second front piece 73. The second front piece 73 defines two second cutouts 731. The second restricting piece 77 defines two second indentations 771 aligned to the two second cutouts 731 one-to-one. Two second elongated ribs 773 protrude from a bounding edge of each second indentation 771. A second restricting groove 775 is defined between the two second elongated ribs 773. Two first hooks 733 are located adjacent to the second front piece 73 and correspond to the two first restricting holes 6331. Two second hooks 751 and two second clipping pieces 753 are located adjacent to the respective second side pieces 75. The two second hooks 751 correspond to the two second restricting holes 6511 of the first case 60, and the two second clipping pieces 753 correspond to the two positioning holes 1311 of the accommodating case 10.

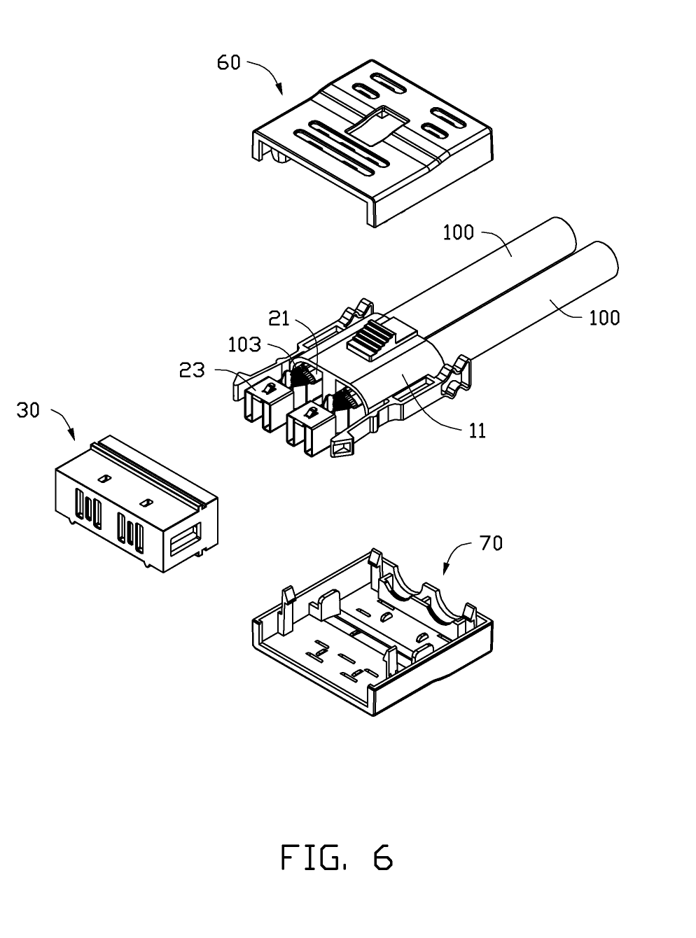

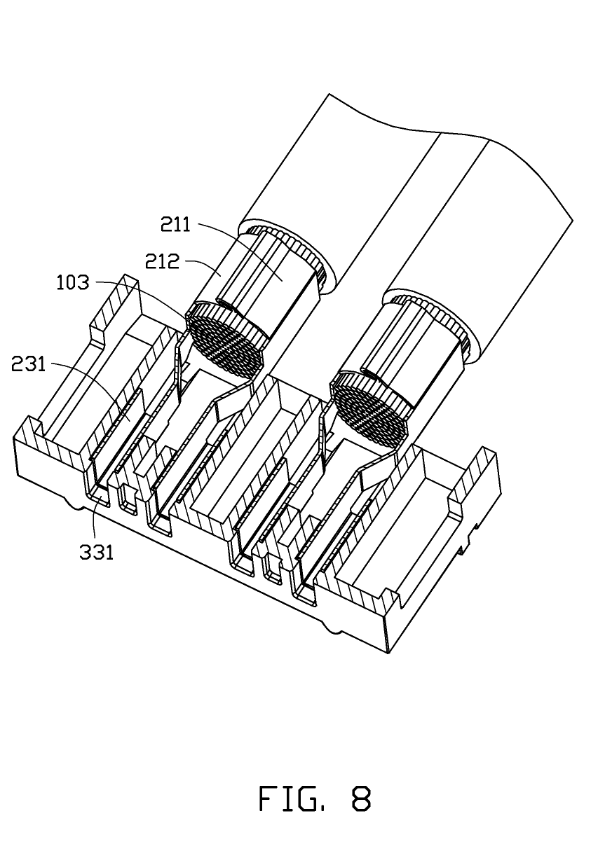

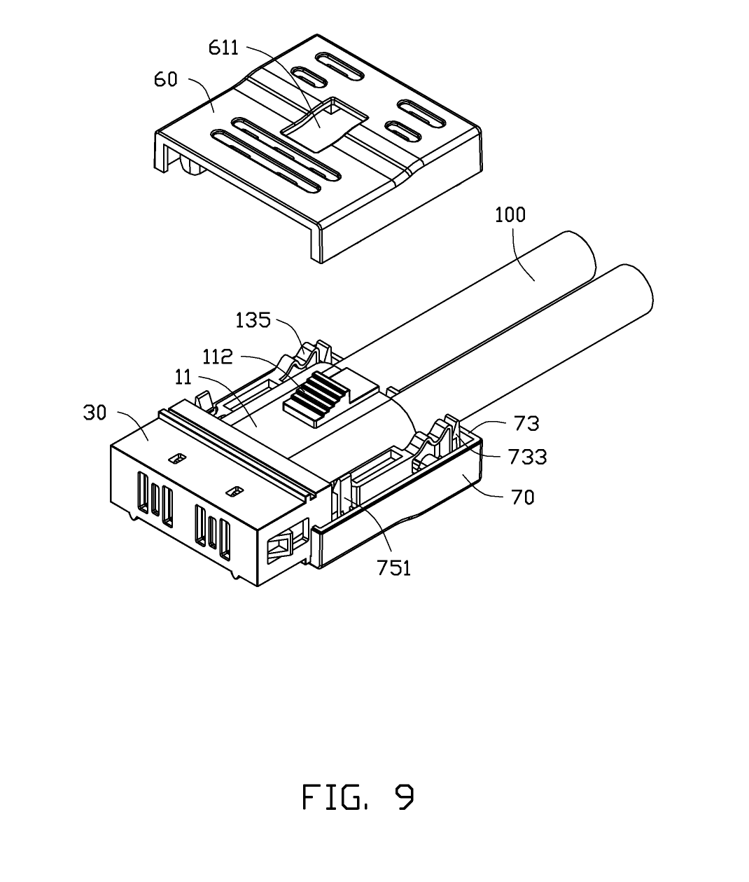

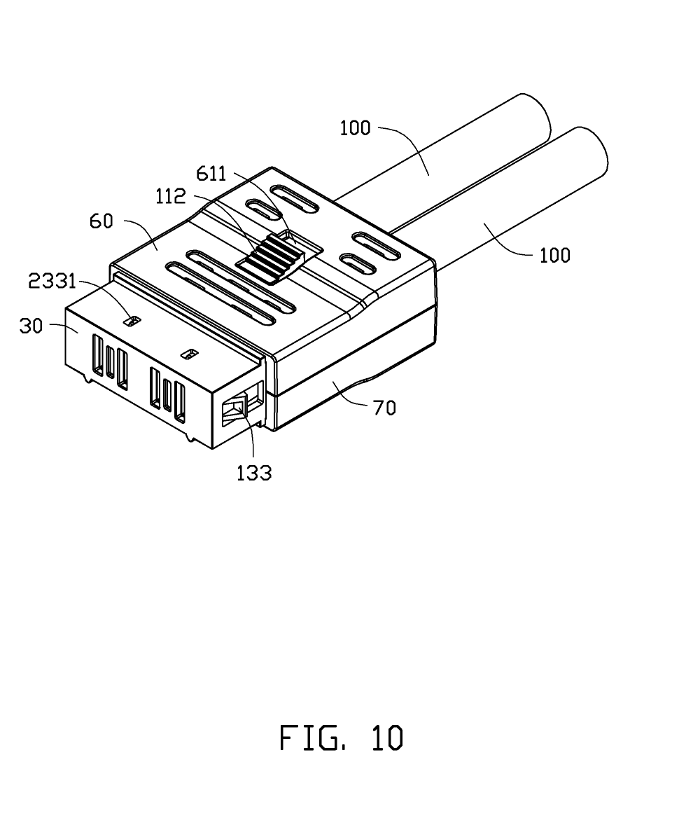

Referring to FIGS. 6-10, to assemble the cable assembly, the cores 103 of the cables 100 are passed through the through hole 113 and the corresponding receiving holes 116. The first conduction piece 211 is detached from the second conduction piece 212. A portion of the core 103 is received between the first conduction piece 211 and the second conduction piece 212, and the first conduction piece 211 and the second conduction piece 212 are attached together to secure the core 103 therebetween. The core 103 is electrically coupled to the conductive sleeve 20. The insulation tubes 101 of the cables 100 are not passed through the receiving holes 116.

The terminals 231 of the conductive sleeves 20 are inserted into the corresponding receiving spaces 301 of the shell 30, with the elastic pieces 2331 inserted into the corresponding restricting holes 311. The engaging arms 13 are inserted into the corresponding engaging spaces 303 of the shell 30, with the clasps 133 latching in the corresponding clasp holes 351. The rib 1331 abuts an inner side of the shell 30. Thus, the cables 100, the conduction sleeve 20, and the shell 30 are assembled together.

To assemble the second case 70 to the accommodating case 10, the second clipping pieces 753 of the second case 70 are inserted into the corresponding positioning holes 1311 of the accommodating case 10, and the cables 100 are passed through the corresponding second indentations 771 and corresponding second cutouts 731. To assemble the first case 60 to the second case 70, the first cutouts 631 and first indentations 671 cooperatively receive the cables 100 with the second cutouts 731 and second indentations 771, respectively. The protrusion 112 is inserted in the opening 611 of the first case 60. The first hooks 733 latch in the corresponding first restricting holes 6331. The second hooks 751 latch in the corresponding second restricting holes 6511. The first clipping pieces 653 are inserted into the corresponding positioning holes 1311. The elastic portions 135 abut inner sides of the first case 60 and second case 70. Therefore, the cable assembly is assembled.

In the above cable assembly, the cores 103 are firmly received between the first conduction piece 211 and the second conduction piece 212. Therefore, even if the cable assembly is used for a long time, the cores 103 can stay stably electrically coupled to the conductive sleeve 20.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A cable assembly, comprising:
a cable comprising a core and an insulation tube wrapped on the core;
a conductive sleeve comprising a wrapping piece comprising a first conduction piece and a second conduction piece, the first conduction piece comprising a first wrap portion, a first connection portion, and a second connection portion, the first connection portion and the second connection portion connected to opposite ends of the first wrap portion, the second conduction piece comprising a second wrap portion, a third connection portion, and a fourth connection portion, the third connection portion and the fourth connection portion connected to opposite ends of the second wrap portion;
wherein the core is located between the first wrap portion and the second wrap portion, the first wrap portion and the second wrap portion are configured to be secured together by the first connection portion connecting the fourth connection portion and the second connection portion connecting the third connection portion to sandwich the core between the first wrap portion and the second wrap portion.

2. The cable assembly of claim 1, wherein the conductive sleeve further comprises a connecting piece and an extending piece, the connecting piece is connected between the wrapping piece and the extending piece, the extending piece comprises terminals, and the conductive sleeve is made of conductive material.

3. The cable assembly of claim 1, further comprising an accommodating case, wherein the accommodating case comprises a through hole, and the core extends through the through hole.

4. The cable assembly of claim 3, further comprising a shell, wherein the accommodating case comprises a clasp, the shell defines a clasp hole, and the clasp engages in the clasp hole.

5. The cable assembly of claim 4, wherein the conductive sleeve comprises an elastic piece, the shell defines a restricting hole, and the elastic piece is inserted in the restricting hole.

6. The cable assembly of claim 3, further comprising a first case, wherein the first case comprises a first clipping piece, the accommodating case comprises an engaging arm, the engaging arm defines a positioning hole, and the first clipping piece is positioned in the positioning hole in a first direction.

7. The cable assembly of claim 6, further comprising a second case, wherein the second case comprises a second clipping piece, and the second clipping piece is positioned in the positioning hole in a second direction opposite to the first direction.

8. The cable assembly of claim 7, wherein the first case and the second case together receives the conduction sleeve and the accommodating case therein.

9. The cable assembly of claim 8, wherein the first case defines a first cutout, the second case defines a second cutout aligned to the first cutout, and the cable is received in the first cutout and the second cutout.

10. A cable assembly, comprising:
a cable comprising a core; and
a conductive sleeve comprising a wrapping piece, the wrapping piece comprises a first conduction piece and a second conduction piece, wherein the first conduction piece and the second conduction piece are configured to be secured together to sandwich the core there between and elastically connected to the core.

11. The cable assembly of claim 10, wherein the first conduction piece comprising a first wrap portion, a first connection portion, and a second connection portion, the first connection portion and the second connection portion connected to opposite ends of the first wrap portion; the second conduction piece comprising a second wrap portion, a third connection portion, and a fourth connection portion, the third connection portion and the fourth connection portion connected to opposite ends of the second wrap portion; the core is located between the first wrap portion and the second wrap portion, the first wrap portion and the second wrap portion are secured together by the first connection portion connecting the fourth connection portion and the second connection portion connecting the third connection portion to sandwich the core between the first wrap portion and the second wrap portion.

12. The cable assembly of claim 11, wherein the conductive sleeve further comprises a connecting piece and an extending piece, the connecting piece is connected between the wrapping piece and the extending piece, the extending piece comprises terminals, and the conductive sleeve is made of conductive material.

13. The cable assembly of claim 10, further comprising an accommodating case, wherein the accommodating case comprises a through hole, and the core extends through the through hole.

14. The cable assembly of claim 13, further comprising a shell, wherein the accommodating case comprises a clasp, the shell defines a clasp hole, and the clasp engages in the clasp hole.

15. The cable assembly of claim 14, wherein the conductive sleeve comprises an elastic piece, the shell defines a restricting hole, and the elastic piece is inserted in the restricting hole.

16. The cable assembly of claim 13, further comprising a first case, wherein the first case comprises a first clipping piece, the accommodating case comprises an engaging arm, the engaging arm defines a positioning hole, and the first clipping piece is positioned in the positioning hole in a first direction.

17. The cable assembly of claim 16, further comprising a second case, wherein the second case comprises a second clipping piece, and the second clipping piece is positioned in the positioning hole in a second direction opposite to the first direction.

18. The cable assembly of claim 17, wherein the first case and the second case together receives the conduction sleeve and the accommodating case therein.

19. The cable assembly of claim 18, wherein the first case defines a first cutout, the second case defines a second cutout aligned to the first cutout, and the cable is received in the first cutout and the second cutout.
